(19) United States
(12) Patent Application Publication
(10) Pub. No.: US 2009/0286471 A1
(43) Pub. Date: Nov. 19, 2009

(54) Method for Allocating Power to Source and Relay Stations in Two-Hop Amplify-and-Forward Relay Multi-Input-Multi-Output Networks

(76) Inventors: Jun Ma, Atlanta, GA (US); Jinyun Zhang, Cambridge, MA (US); Philip V. Orlik, Cambridge, MA (US)

Correspondence Address: MITSUBISHI ELECTRIC RESEARCH LABORATORIES, INC., 201 BROADWAY, 8TH FLOOR, CAMBRIDGE, MA, 02139, US

(21) Appl. No.: 12/120,332

(22) Filed: May 14, 2008

(51) Int. Cl. H04B 1/62

(52) U.S. Cl. 455/10

(57) ABSTRACT

Disclosed is a method for static power allocation to source and relay stations in a two-hop amplify-and-forward (AF) relay multi-input-multi-output (MIMO) network including of a source station (SS), a relay station (RS), and a destination station (DS) each transmitting signals using multiple antennas. The method performs power allocation to the SS and the RS according to the path loss, or equivalently, according to a distances, between the SS and the RS and the RS and DS. The transmit power of each transmit antenna at the SS and the power amplifying gain of the RS are determined from the power allocation outputs.

### FIELD OF THE INVENTION

This invention relates generally to relay assisted cooperative communication, and more particularly to allocating power to a source station (SS) and a relay station (RS) in a two-hop amplify-and-forward (AF) relay multi-input-multi-output (MIMO) network.

### BACKGROUND OF THE INVENTION

Cooperative communication is regarded as one of the critical techniques to be used in next generation wireless communication networks. A typical single-user relay assisted cooperative communication network includes a source station (SS), one or more relay stations (RSs), and a destination station (DS). The RS receives a signal from the SS, performs appropriate signal processing, and then relays the signal to the DS. Relay techniques can increase the coverage of communication, decrease the total transmit power consumed, and increase the capacity and reliability of the network due to multiple independent paths from the source to the destination.

Depending on how much signal processing is performed at the RS, relay modes can be decode-and-forward (DF) and amplify-and-forward (AF). A RS operating in the DF mode demodulates and decodes the received signal, corrects possible errors, re-modulates the signal and then forwards the signal to the DS. In contrast, a RS operating in the AF mode only amplifies and forwards the received signals without decoding the signals. Thus, the relay station in the AF mode has a much simpler structure to achieves a tradeoff between performance and complexity.

In a two-hop relay cooperative communication network, the SS and the RS can concurrently transmit signals over the same channel, while the DS jointly detects the signals. Alternatively, the SS and the RS can transmit the signals over two orthogonal channels by means of time-division or frequency-division multiplexing to reduce interference. In either case, cooperative diversity can be achieved by allowing the DS to concurrently receive the signals from both the SS and the RS.

In a scattering environment, multi-path fading varies significantly on the scale of half the wavelength of the carrier frequency. Multiple-input-multiple-output (MIMO) techniques take advantage of the inherent spatial diversity in wireless channels by utilizing multiple antennas at both the transmitter and the receiver. MIMO techniques have been widely used to enhance the spectrum efficiency or reliability of the wireless communication network. This is evident by the use of MIMO in wireless communication standards such as IEEE 802.11n and IEEE 802.16.

In the two-hop AF relay MIMO network, it is necessary to allocate transmit power to the SS and the RS so as to either maximize an overall network performance under some transmit power constraint, or to minimize the total transmit power under some quality of service (QoS) constraint.

One dynamic power allocation method maximizes the instantaneous capacity of the two-hop AF relay MIMO network, Hammerstrom et al., “Power allocation schemes for amplify-and-forward MIMO-OFDM relay links,” IEEE trans. on wireless commun., vol. 6, no. 8, pp. 2798-2802, August 2007. While that dynamic power allocation method optimizes the network performance, it requires instantaneous channel state information (CSI) for the SS to RS channel and the RS to DS channel. That makes the method extremely complex.

It is desired to provide a low-complexity method that allocates power to the SS and the RS of a two-hop amplify-and-forward relay multi-input-multi-output (MIMO) network.

### SUMMARY OF THE INVENTION

The embodiments of the invention allocate static power allocation in a two-hop amplify-and-forward (AF) relay multi-input-multi-output (MIMO) network. The network includes a source station (SS), a relay station (RS), and a destination station (DS). In an alternative embodiment, there can be multiple relay stations.

As defined herein, static means that the power allocation method is based on a static path loss, instead of an instantaneous channel state information over the SS to RS and RS to DS channels (hops). Therefore, the method has a good tradeoff between performance and complexity. The method realizes optimal static power allocation in the sense that the method maximizes an upper bound of an average capacity of the two-hop AF relay MIMO network under an average total transmit power constraint.

### BRIEF DESCRIPTION OF THE DRAWINGS

FIG. 1 is a schematic of the two-hop AF relay cooperative communication network operating according to the embodiments of the invention;

FIG. 2 is a block diagram of the two-hop AF relay MIMO network operating according to the embodiments of the invention;

FIG. 3 is a simplified block diagram of the two-lhop AF relay MIMO network operating according to the embodiments of the invention; and

### DETAILED DESCRIPTION OF THE PREFERRED EMBODIMENT

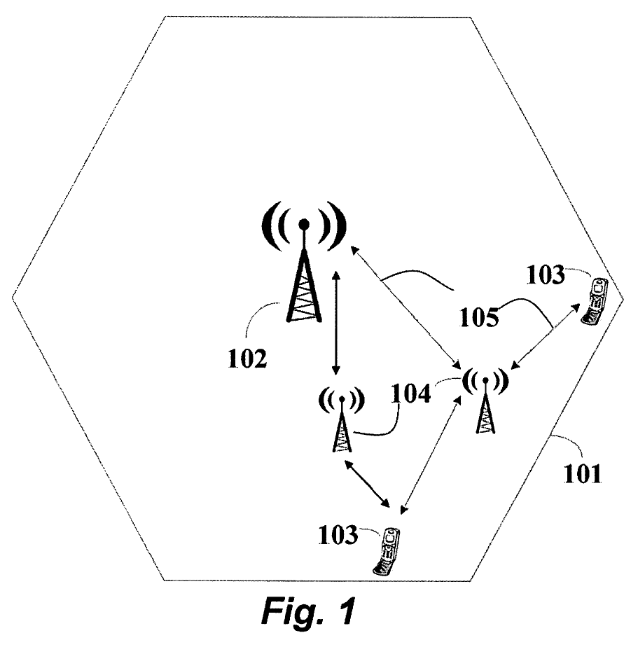

FIG. 1 shows a two-hop relay cooperative communication network capable with static power allocation to a source station (SS) and a relay station (RS) 104 according to the embodiments of our invention. The network can be a wireless local network, a metropolitan area network, or in a wireless cellular (mobile) network. It could be understood that there can be multiple relay stations.

In a service area 101, there is one base station (BS) 102, multiple mobile stations (MS) 103 communicating with the BS in parallel, and one or more of the RSs 104. The RSs assist a remote MS to communicate with the BS. The RS can concurrently assist multiple MSs, while each MS only communicates with only one RS at the time. The RS can be fixed, nomadic, or even mobile.

Depending on a direction of communication, i.e., downlink or uplink, the BS and the mobile stations can operate as the SS or the DS. That is, the communication is considered to be bi-directional between the BS and the MS. Thus, the transmit powers can be optimized in both the uplink and downlink communication channels 105.

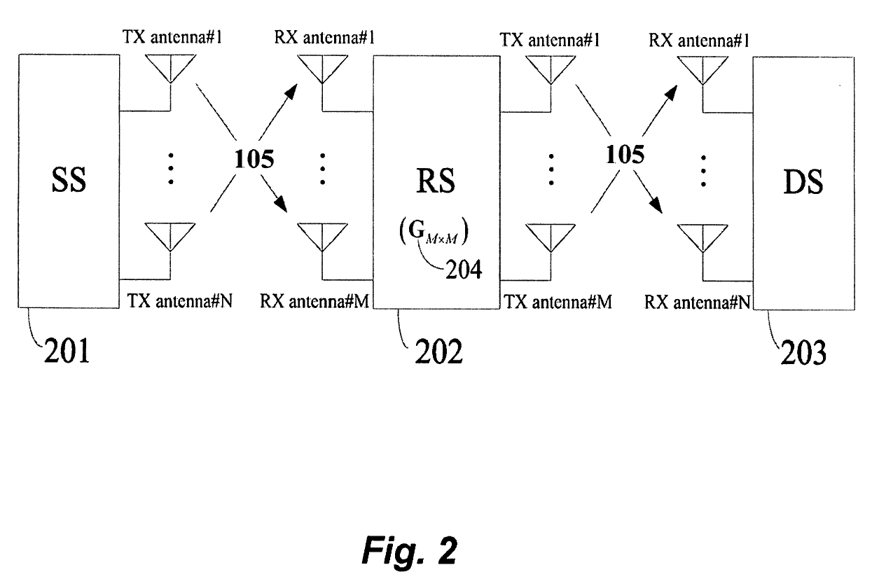

FIG. 2 shows the two-hop AF relay MIMO network. There are N transmit antennas at the SS 201 and the DS 203, and M transmit and receive antennas at the RS 202. There is no direct communication link between the SS and the DS. The link between the SS and the DS is realized by orthogonal channels between the SS and the RS and the RS and the DS, e.g., by time-division, frequency-division, or code-division multiplexing.

The RS operate works in the AF mode, where G 204 is an amplifying gain matrix of dimension M×M, which is usually expressed as G=gU, where U is a unitary matrix of dimension R×R and a scalar g is an amplifying gain. Because the matrix U is unitary, the power amplifying gain of the RS is |g|².

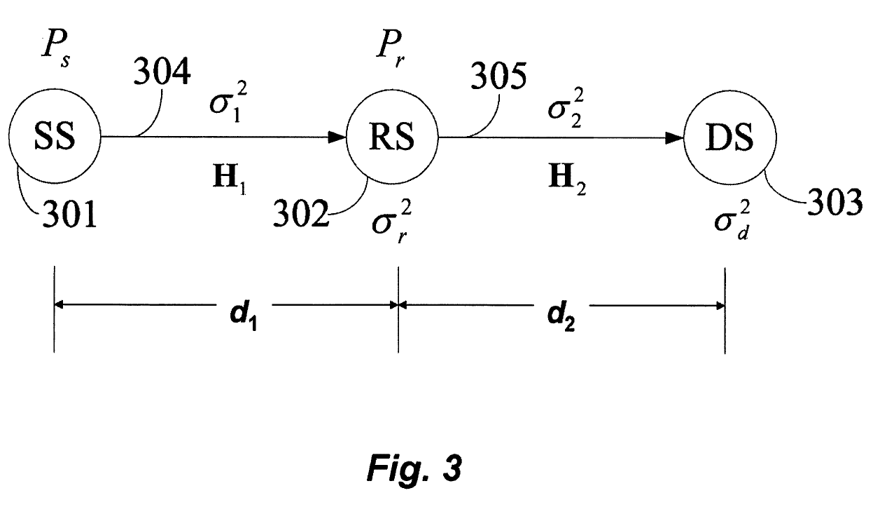

FIG. 3 shows the two-hop AF relay MIMO network. The average total transmit powers are Pₛ and Pᵣ at the SS 301 and RS 302, respectively. The channel matrices, over the first channel 304 from the SS to the RS 304 and the channel 303 from the RS to the DS 305 hops, are H₁ and H₂ with dimensions N×M, respectively.

The path loss over the SS to RS channel 304 and the RS to DS channel 305 are σ₁² and σ₂², respectively, and equivalent to the average powers of the elements of the matrices H₁ and H₂, respectively. As defined herein, the path loss, or path attenuation, is the reduction in power density of the transmitted signal. The path loss can be due to free-space loss, refraction, diffraction, reflection, terrain contour, environment, propagation medium, height and location of antennas, and distance between the transmitter and the receiver.

Noise powers at each antenna of the RS and DS are denoted by σᵣ² and σ_{d}². It can be shown that

Pₛ=MPₓ, (1)

where Pₓ is the transmit power on each transmit antenna of the SS, and

Pᵣ=R|g|²(MPₓσ₁²+σᵣ²). (2)

Our invention determines the transmit power Pₛ for the SS and the transmit power Pᵣ for the RS according to the path loss over the SS to the RS channel and the RS to DS channel, namely σ₁² and σ₂², so as to optimize the network performance under an average total transmit power constraint, such that

P≦Pₛ+Pᵣ,

where P is the maximum average total transmit power of the two-hop relay MIMO network.

To be more specific, our invention determines the static powers Pₛ and Pᵣ that maximizes an upper bound of an average capacity of the two-hop AF relay MIMO network,

$$\overline{C} ( {σ}_{1}^{2} , {σ}_{2}^{2} , {σ}_{r}^{2} , {σ}_{d}^{2} , {P}_{s} , {P}_{r} ) = \frac{N}{2} {log}_{2} ( 1 + \frac{\frac{{P}_{s} {σ}_{1}^{2}}{{σ}_{r}^{2}} • \frac{{P}_{r} {σ}_{2}^{2}}{{σ}_{d}^{2}}}{1 + \frac{{P}_{s} {σ}_{1}^{2}}{{σ}_{r}^{2}} + \frac{{P}_{r} {σ}_{2}^{2}}{{σ}_{d}^{2}}} ) , \qquad ( 3 )$$

subject to P≦Pₛ+Pᵣ. Because our method is based only on the static path loss, it has a low-complexity.

For convenience of notation, we define

$$a = \frac{{σ}_{1}^{2}}{{σ}_{r}^{2}} and \qquad b = \frac{{σ}_{2}^{2}}{{σ}_{d}^{2}}$$

as the average quality of the channels over the SS to RS channel, and the RS to DS channel, respectively. Our optimal transmit powers at the SS and RS, Pₛ* and Pᵣ*, are

$$\begin{matrix}{P}_{s}^{*} = \{ \begin{matrix} \frac{\begin{matrix}\sqrt{( 1 + aP ) ( 1 + bP )} - \\ ( 1 + bP )\end{matrix}}{a - b} , & a \neq b , \\ \frac{1}{2} P , & a = b ,\end{matrix} \\ and & ( 4 ) \\ {P}_{r}^{*} = \{ \begin{matrix} \frac{\begin{matrix}\sqrt{( 1 + bP ) ( 1 + aP )} - \\ ( 1 + bP )\end{matrix}}{b - a} , & a \neq b , \\ \frac{1}{2} P , & a = b .\end{matrix} , & ( 5 )\end{matrix}$$

The power Pₓ on each transmit antenna of the SS, and the power amplifying gain |g|² the RS can be obtained from Equations (1) and (2) as

$${P}_{x}^{*} = \frac{{P}_{s}}{M} , and {\vert g \vert}^{{2}^{*}} = \frac{{P}_{r}^{*}}{R ( {MP}_{x}^{*} {σ}_{1}^{2} + {σ}_{r}^{2} )} . \qquad ( 6 )$$

According to this power allocation,

$$\frac{{P}_{r}^{*}}{{P}_{s}^{*}} = \sqrt{\frac{1 + aP}{1 + bP}} ,$$

and

$$\{ \begin{matrix}{P}_{r}^{*} > {P}_{s}^{*} , & a > b , \\ {P}_{r}^{*} = {P}_{s}^{*} , & a = b , \\ {P}_{r}^{*} < {P}_{s}^{*} , & a < b ,\end{matrix} \qquad ( 7 )$$

which indicates that our static power allocation method allocates more power to the channel with a worse average quality, namely a larger path loss, so as to improve the overall average quality of our two-hop AF relay MIMO network.

For Equations (4)-(7), the SS and the RS measure the path loss σ₁² for the channel from the SS to the RS and the path loss σ₂² from the RS to the DS, as well as the corresponding the noise powers σᵣ² and σ_{d}².

The path loss can be measure from the received signal strength (RSS) and the known transmit power. This can be achieved while transmitting pilot or preamble symbols used for synchronization the stations.

During this time, each receiver can measure the average RSS. If pilot and the preamble symbols are transmitted at a known average power Pₚ, then the path loss is Pₚ-RSS.

In one embodiment of our invention we consider the case that where either or both the SS and the RS have individual power constraints. The MSs are generally battery powered and have restriction on transmit power to satisfy battery lifetime constraints, or power control techniques are enforced to limit interference. If the RS are mobile, they are similarly constrained.

In this case, the individual power constraints at the SS and the RS are Pₛₘₐₓ, and Pᵣₘₐₓ, respectively. The individual power constraints satisfy P≦Pₛₘₐₓ+Pᵣₘₐₓ. In this case, we determine the optimal powers according to Equations (4) and (5), and then check if the individual power constraints are violated. Then, we revise the above power allocation outputs to be

$$\{ \begin{matrix}{P}_{s}^{**} = {P}_{s , max} , {P}_{r}^{**} = P - {P}_{s}^{**} , & {P}_{s}^{*} > {P}_{s , max} , \\ {P}_{r}^{**} = {P}_{r . max} , {P}_{s}^{**} = P - {P}_{r}^{**} , & {P}_{r}^{*} > {P}_{r . max} , \\ {P}_{s}^{**} = {P}_{s}^{*} , {P}_{r}^{**} = {P}_{r}^{*} , & {P}_{s}^{*} \leq {P}_{s , max} , {P}_{s}^{*} {\leq }_{r . max} ,\end{matrix} \qquad ( 8 )$$

where Pₛ** and Pᵣ** are the final average transmit powers allocated to the SS and RS, respectively.

For the special case of a two-hop AF relay single-input-single-output (SISO) network, this static power allocation is still applicable. For the multi-user station, our invention performs the static power allocation between the SS and RS for each station independently because different stations are allocated orthogonal channels. In this case, the RSs are capable of differentiating channels allocated to different MSs so that the RS can determine the power amplifying gains for the different MSs.

If the path loss of the channels over the SS-RS and RS-DS are modeled according to the distance d₁ between the SS and RS, and the distance d₂ between the RS and the DS, respectively, then our static power allocation method is equivalently based on the distances of over the SS-RS and RS-DS hops, or, more simply, based on the relative locations of the SS, RS and DS, thus further simplifying the power allocation method.

Because our static power allocation method is based on the static path loss of the channels over the SS-RS and RS-DS hops, it has much less complexity than the conventional method that is based on the instantaneous channel state information. Moreover, our static power method is optimal in the sense that it maximizes the upper bound of the average capacity of the two-hop AF relay MIMO network, C̅ (σ₁², σ₂², σᵣ², σ_{d}², Pₛ, Pᵣ).

Although the invention has been described by way of examples of preferred embodiments, it is to be understood that various other adaptations and modifications can be made within the spirit and scope of the invention. Therefore, it is the object of the appended claims to cover all such variations and modifications as come within the true spirit and scope of the invention.

We claim:

1. A method for allocating static power in a two-hop amplify-and-forward (AF) relay multi-input-multi-output (MIMO) network including a source station (SS), a relay stations (RSs), and a destination station (DS), in which each station transmits a signal using multiple antennas, comprising:
measuring a first path loss σ₁² for a first channel from the SS to RS and a second path loss σ₂² for a second channel from the RS to the DS,
allocating first power Pₛ to the SS and a second power Pᵣ to the RS based on the path losses σ₁ and σ₂² such that an average total transmit power P is constrained according to P≦Pₛ+Pᵣ;
transmitting the signal from the SS to the RS on the first channel using the first power Pₛ;
amplifying the signal received at the RS; and
transmitting the amplified signal to the DS on the second channel using the second power Pᵣ, and in which the second channel is orthogonal to the first channel.

2. The method of claim 1, in which the static powers Pₛ and Pᵣ maximize an upper bound of an average capacity of the two-hop AF relay MIMO network.

3. The method of claim 1, in which more power is allocated to the channel with a larger path loss.

4. The method of claim 1, further comprising:
measuring a first noise power σᵣ² at the RS and a second noise power σ_{d}² at the DS.

5. The method of claim 1, in which the path loss for each channel is an average transmit power minus a received signal strength.

6. The method of claim 1, in which the allocating is based on elements of channel matrices H₁ and H₂ of the first channel and the second channel.

7. The method of claim 1, in which the first power is based on a first distance between the SS to the RS, and the second power is based on a second distance between the RS and DS.

8. The method of claim 1, in which the allocation is based on relative locations of the SS, RS, and DS.

9. The method of claim 1, in which the first power is a maximum allowable average transmit power, and the second power is the average total transmit power minus the first power.

10. The method of claim 1, in which the second power is a maximum allowable average transmit power and the first power is the average total transmit power minus the second power.
